(19) United States
(12) Patent Application Publication
(10) Pub. No.: US 2014/0182870 A1
(43) Pub. Date: Jul. 3, 2014

(54) HANDHELD TOOL DEVICE

(71) Applicant: Tobias HERR, Stuttgart (DE)

(72) Inventor: Tobias HERR, Stuttgart (DE)

(73) Assignee: Robert Bosch GmbH, Stuttgart (DE)

(21) Appl. No.: 13/741,951

(22) Filed: Jan. 15, 2013

(30) Foreign Application Priority Data
Dec. 27, 2012 (DE) 102011089914.6

(51) Int. Cl. B25D 16/00; B25B 21/02

(52) U.S. Cl. CPC B25D 16/00; B25B 21/02
USPC 173/94; 173/104

(57) ABSTRACT

A handheld tool apparatus having a tool guidance unit, which has a tool spindle and a tool chuck, and having an impact mechanism which has a striker that in at least one operating state percussively drives the tool guidance unit. It is provided that a mass of the striker be at maximum two thirds as great as a mass of the tool guidance unit.

### RELATED APPLICATION INFORMATION

The present application claims priority to and the benefit of German patent application no. 10 2011 089 914.6, which was filed in Germany on Dec. 27, 2012, the disclosure of which is incorporated herein by reference.

### FIELD OF THE INVENTION

The present invention relates to a handheld tool apparatus having a tool guidance unit and an impact mechanism.

### BACKGROUND INFORMATION

A handheld tool apparatus having a tool guidance unit that has a tool spindle and a tool chuck, and having an impact mechanism which has a striker that in at least one operating state percussively drives the tool guidance unit, is understood to have been proposed.

### SUMMARY OF THE INVENTION

The exemplary embodiments and/or exemplary methods of the present invention proceed from a handheld tool apparatus having a tool guidance unit that has a tool spindle and a tool chuck, and having an impact mechanism which has a striker that in at least one operating state percussively drives the tool guidance unit.

It is provided that a mass of the striker be at maximum two thirds as great as a mass of the tool guidance unit. A “tool guidance unit” is to be understood in particular as a unit which is provided for securing an inserted tool at least rotatably. The tool guidance unit may be mounted rotatably around a rotation axis, in particular at at least two points differing in an axial direction. The tool spindle and at least parts of the tool chuck may be connected immovably relative to one another at least in an axial direction. Advantageously, the tool spindle and at least parts of the tool chuck are connected nonrotatably to one another. “Provided” is to be understood to mean, in particular, specifically designed and/or equipped. A “tool spindle” is to be understood in particular as a shaft that transfers a rotational motion from a planetary gearbox of the handheld tool apparatus to the tool chuck. The tool spindle may be embodied as a solid shaft. Alternatively, the tool spindle could also be embodied as a hollow shaft.

A “planetary gearbox” is in particular a gearbox having at least one planetary gearbox stage. A “tool chuck” is to be understood in particular as an apparatus which is provided for securing different inserted tools in a manner replaceable by an operator. An “impact mechanism” is to be understood in particular as an apparatus which is provided for generating a percussive pulse and delivering it in particular in the direction of an inserted tool. The impact mechanism may convey the percussive pulse, at least in an impact-drill operating mode, advantageously via a tool spindle and via a tool chuck of the handheld tool apparatus to the inserted tool. The impact mechanism may be provided for converting a rotational motion into an, in particular, translational percussive motion. The term “striker” is to be understood in particular as an arrangement that, at least in an impact-drill operating mode, is accelerated in particular translationally and delivers a pulse, received upon acceleration, as a percussive pulse in the direction of the inserted tool. The striker may be embodied as one part.

Alternatively, the striker could be embodied as multiple parts. At least in an impact-drill operating mode, the striker may strike an impact surface of the tool guidance unit, in particular an impact surface of the tool chuck and/or advantageously an impact surface of the tool spindle. The expression “percussively drive” is to be understood in particular to mean that at least in an impact-drill operating mode, the striker transfers a percussive pulse to the tool guidance unit. A “mass of the striker” is to be understood in particular as a mass that is translationally accelerated by the impact mechanism at least in an impact-drill operating mode and, upon an impact on the tool guidance unit, delivers to the tool guidance unit a pulse received as a result of the translational acceleration. A “mass of the tool guidance unit” is to be understood in particular, at least in an impact-drill operating mode, as a mass fixedly connected to the tool chuck, in particular without an inserted tool. The expression that “a mass of the striker is at maximum two thirds as great as a mass of the tool guidance unit” is to be understood in particular to mean that a mass of the striker is equal at maximum to 66.7% of a mass of the tool guidance unit. The configuration according to the present invention allows an advantageously low total weight to be achieved with particularly high performance.

In a further embodiment, it is proposed that the mass of the striker be at maximum half as great as the mass of the tool guidance unit, thereby making possible a particularly low total weight. The expression that “a mass of the striker is at maximum half as great as the mass of the tool guidance unit” is to be understood in particular to mean that a mass of the striker is equal at maximum to 50% of a mass of the tool guidance unit.

It is further proposed that a mass of the striker be equal to at minimum 35%, advantageously at minimum 40%, particularly advantageously at minimum 45% of a mass of the tool guidance unit, with the result that a particularly high-performance impact mechanism can be made available.

It is further proposed that the tool spindle have an impact surface onto which the striker strikes in at least one operating mode, with the result that particularly stable mounting of the tool chuck and an uncomplicated design can be achieved. An “impact surface” is to be understood in particular as a surface of the tool spindle through which the striker, in at least one operating state, transfers the percussive pulse to the tool spindle.

It is additionally proposed that the striker surround the tool spindle on at least one plane, thereby making possible a configuration of low volume and weight. The expression “at least substantially surround on at least one plane” is to be understood to mean that rays proceeding from an axis of the impact mechanism spindle that are disposed on the plane intersect the striker through an angular range of at least 180 degrees, advantageously at least 270 degrees. Particularly advantageously, the striker surrounds the impact mechanism spindle through 360 degrees.

In an advantageous embodiment of the invention, it is proposed that the impact mechanism have at least one cam guide that drives the striker at least in an impact-drill operating mode, with the result that a particularly small, light, and nevertheless high-performance impact mechanism can be made available. In particular, a wobble bearing or rocker arm can advantageously be omitted. A “cam guide” is to be understood in particular as an apparatus that converts a rotational energy for impact generation, at least by way of a specifically shaped guidance surface along which a connecting arrangement runs at least in an impact-drill operating mode, into a linear motion energy of the striker. The impact mechanism may have an impact mechanism spring that stores the linear motion energy of the striker for impact generation. The specifically shaped surface may be a surface that delimits a guidance cam for cam guidance. A “connecting arrangement” is to be understood in particular as an arrangement or means that creates a mechanical coupling between at least one part (in particular the impact mechanism spindle) of the impact mechanism which is rotationally moved in an impact-drill operating mode, and the (in particular, linearly) moved striker. “Drive” is to be understood in this connection to mean in particular that the cam guide transfers to the striker an energy for impact generation.

It is further proposed that the striker encompass a part of the cam guide, the result being that a high impact energy and advantageously low wear can be achieved with a short overall length.

It is additionally proposed that the impact mechanism have an impact mechanism spring that accelerates the striker in an impact direction at least in an impact-drill operating mode, the result being that a hammer tube can be omitted, making possible a particularly light and small configuration. An “impact mechanism spring” is to be understood in particular as a spring that, in at least one operating state, stores at least a part of an impact energy. The impact mechanism spring is embodied as a spring that seems appropriate to one skilled in the art, but may be embodied as a helical spring. An “impact direction” is to be understood in particular as a direction that extends parallel to a rotation axis of the tool chuck and is oriented from the striker toward the tool chuck. “Accelerate” is to be understood in this connection to mean in particular that the impact mechanism spring produces on the striker, in at least one operating state, a force that moves the striker with increasing velocity.

It is moreover proposed that the impact mechanism have an impact mechanism spindle that surrounds the tool spindle on at least one plane, thereby making possible a configuration of low volume and weight. An “impact mechanism spindle” is to be understood in particular as a shaft that transfers a rotational motion from a planetary gearbox of the handheld tool apparatus to the cam guide. The impact mechanism spindle may be embodied as a hollow shaft.

It is further proposed that the impact mechanism have a striker guide that nonrotatably mounts the striker, thereby making possible a cam guide of simple design. A “striker guide” is to be understood in particular as an apparatus that mounts the striker movably parallel to the impact direction. The term “mount nonrotatably” is to be understood in particular to mean that the striker guide counteracts in particular any rotational motion of the striker relative to a handheld tool housing.

The invention further proceeds from a handheld tool having a handheld tool apparatus according to the present invention. The handheld tool may be provided in order to drive the inserted tool in a screwdriving mode, in a drilling mode, in an impact drilling mode, and in particular in a hammer mode.

Further advantages are evident from the description below of the drawings. The drawings depict five exemplifying embodiments of the present invention. The drawings, the specification, and the claims contain numerous features in combination. One skilled in the art will expediently also consider the features individually, and combine them into useful further combinations.

### BRIEF DESCRIPTION OF THE DRAWINGS

FIG. 1 is a section through a handheld tool having a handheld tool apparatus according to the present invention.

FIG. 2 is a partly exposed section through an impact mechanism and a planetary gearbox of the handheld tool apparatus of FIG. 1.

FIG. 3 shows a first section surface A of the impact mechanism of the handheld tool apparatus of FIG. 1.

FIG. 4 shows a second section surface B of the impact mechanism of the handheld tool apparatus of FIG. 1.

FIG. 5 is a perspective depiction of an impact mechanism spindle of the impact mechanism of the handheld tool apparatus of FIG. 1.

FIG. 6 is a perspective depiction of a striker of the impact mechanism of the handheld tool apparatus of FIG. 1.

FIG. 7 shows a section surface C of a first planetary gearbox stage and of a first impact deactivation apparatus of the handheld tool apparatus of FIG. 1.

FIG. 8 shows a section surface D of a control element and of a second impact deactivation apparatus of the handheld tool apparatus of FIG. 1.

FIG. 9 is a perspective sectioned depiction of a part of the handheld tool apparatus of FIG. 1.

FIG. 10 shows a section surface E of a spindle blocking apparatus of the handheld tool apparatus of FIG. 1.

FIG. 11 shows a section surface F through a blocking arrangement of the spindle blocking apparatus of the handheld tool apparatus of FIG. 1.

FIG. 12 shows a section surface G of a second planetary gearbox stage of the handheld tool apparatus of FIG. 1.

FIG. 13 shows a section surface H of a third planetary gearbox stage of the handheld tool apparatus of FIG. 1.

FIG. 14 shows a section surface I of a fourth planetary gearbox stage of the handheld tool apparatus of FIG. 1.

FIG. 15 schematically depicts an operating apparatus and a protective apparatus of the handheld tool apparatus of FIG. 1.

FIG. 16 shows an alternative exemplifying embodiment of a first impact deactivation apparatus of a handheld tool apparatus according to the present invention.

FIG. 17 shows a further exemplifying embodiment of a first impact deactivation apparatus of a handheld tool apparatus according to the present invention.

FIG. 18 shows an alternative exemplifying embodiment of an impact switching spring of a handheld tool apparatus according to the present invention. and

FIG. 19 shows an alternative exemplifying embodiment of an operating apparatus and a protective apparatus of a handheld tool apparatus according to the present invention.

### DETAILED DESCRIPTION

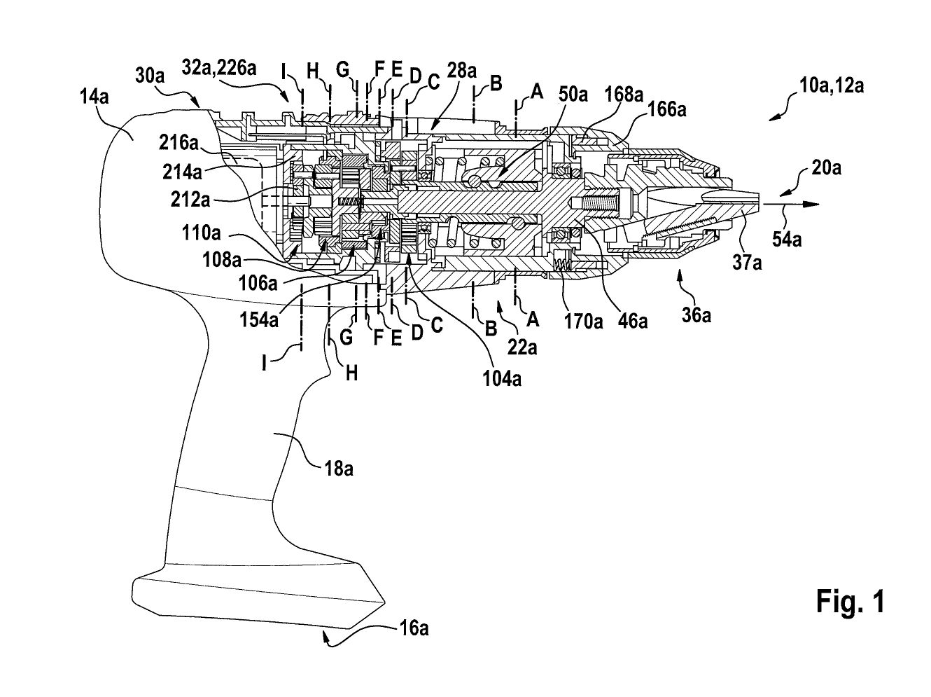

FIG. 1 shows a handheld tool 10a. Handheld tool 10a is embodied as an impact drill driver. Handheld tool 10a has a handheld tool apparatus 12a according to the present invention, a handheld tool housing 14a, and a rechargeable battery interface 16a. Rechargeable battery interface 16a is provided in order to provide handheld tool apparatus 12a with electrical energy from a handheld tool rechargeable battery (not depicted in further detail). Handheld tool housing 14a is pistol-shaped. Handheld tool housing 14a is embodied in multiple parts. It encompasses a handle 18a with which an operating holds handheld tool 10a in the context of a working operation. Handheld tool apparatus 12a encompasses a tool guidance unit 20a, an impact mechanism 22a, a first impact deactivation apparatus 24a, a second impact deactivation apparatus 26a, a planetary gearbox 28a, a drive unit 30a, an operating apparatus 32a, and a torque limiting unit 34a.

Tool guidance unit 20a encompasses a tool chuck 36a and a tool spindle 38a. Tool chuck 36a secures an inserted tool (not depicted here), for example a drill or a screwdriver bit, in the context of a working operation. Tool chuck 36a secures the inserted tool frictionally. Tool chuck 36a has three clamping jaws, secured in a manner movable by an operator, that secure the inserted tool in the context of a working operation. In addition, tool chuck 36a secures the inserted tool axially immovably with respect to tool chuck 36a, and in particular with respect to tool spindle 38a, in the context of a working operation. Tool spindle 38a and a part of tool chuck 36a are connected to each other immovably relative to one another. Tool chuck 36a and tool spindle 38a are here bolted to one another. Handheld tool apparatus 12a has a mounting arrangement 40a that mounts tool spindle 38a on a side facing toward tool chuck 36a. Mounting arrangement 40a mounts tool spindle 38a axially displaceably. Mounting arrangement 40a is connected axially fixedly to tool spindle 38a. Mounting arrangement 40a is mounted axially movably in handheld tool housing 14a. Handheld tool apparatus 12a has a further mounting arrangement 41a that mounts tool spindle 38a on a side facing toward planetary gearbox 28a. Mounting arrangement 41a is embodied as a rolling bearing, in this case as a needle bearing, thereby making possible low-clearance mounting. Mounting arrangement 41a mounts tool spindle 38a axially displaceably. An impact mechanism spindle 46a surrounds mounting arrangement 41a. Mounting arrangement 41a is disposed in terms of effect between tool spindle 38a and impact mechanism spindle 46a.

Tool spindle 38a encompasses an impact surface 42a onto which a striker 44a of impact mechanism 22a strikes in an impact-drill operating mode. Striker 44a has a mass that is at maximum two-thirds as great as a mass of tool guidance unit 20a. Here the mass of striker 44a is less than half as great as the mass of tool guidance unit 20a. The mass of striker 44a is equal to approximately 45% of the mass of tool guidance unit 20a.

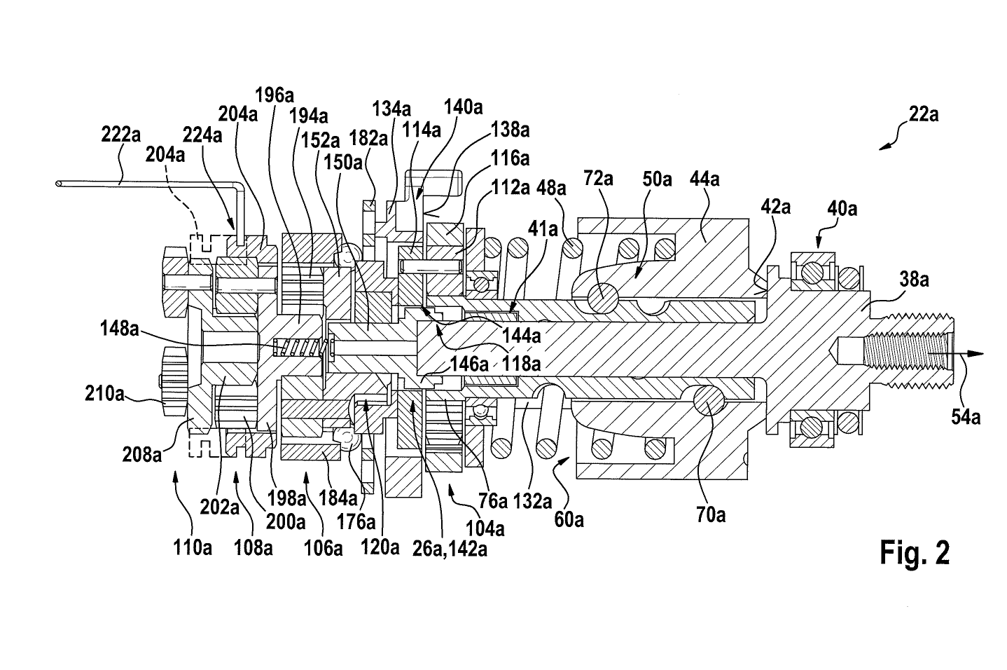

FIG. 2a depicts impact mechanism 22a and planetary gearbox 28a in more detail. Impact mechanism 22a encompasses striker 44a, impact mechanism spindle 46a, an impact mechanism spring 48a, a striker drive apparatus 50a, and a striker guide 52a. Striker 44a is mounted translationally movably in impact direction 54a. Impact direction 54a is oriented parallel to an axial direction of impact mechanism spindle 46a.

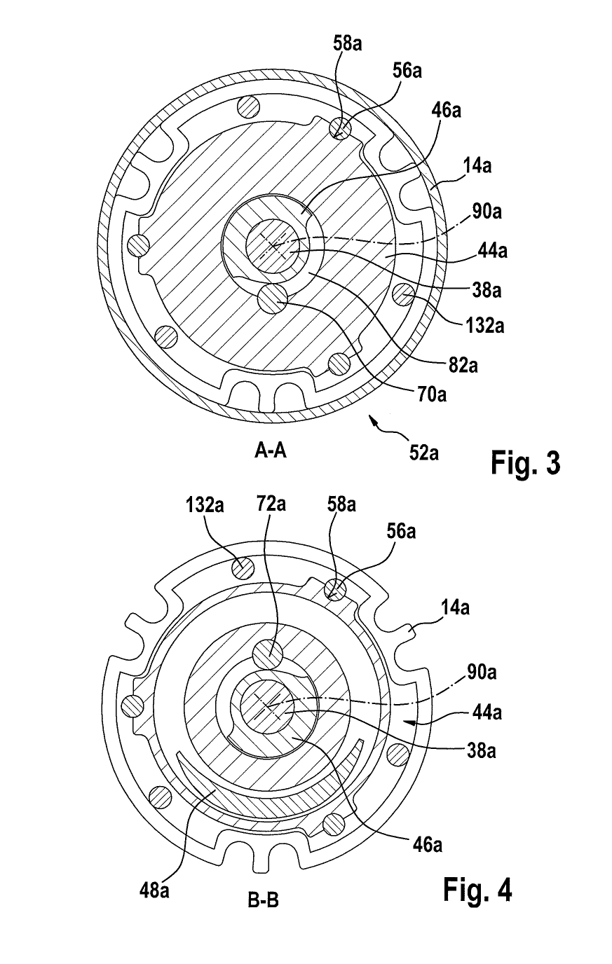

FIGS. 3 and 4 show a section surface A and a section surface B of impact mechanism 22a. Striker guide 52a mounts striker 44a nonrotatably relative to handheld tool housing 14a. Striker guide 52a has three guide rods 56a on which striker 44a slides. Guide rods 56a are disposed regularly around striker 44a. Striker 44a has sliding surfaces 58a that surround guide rods 56a through 180 degrees on a plane perpendicular to impact direction 54a. Striker 44a surrounds impact mechanism spindle 46 through 360 degrees on a plane that is oriented perpendicular to impact direction 54a. In addition, striker 44a surrounds tool spindle 38 through 360 degrees on the plane. Impact mechanism spindle 46a further surrounds tool spindle 38a through 360 degrees on the plane. Impact mechanism spindle 46a is disposed coaxially with tool spindle 38a.

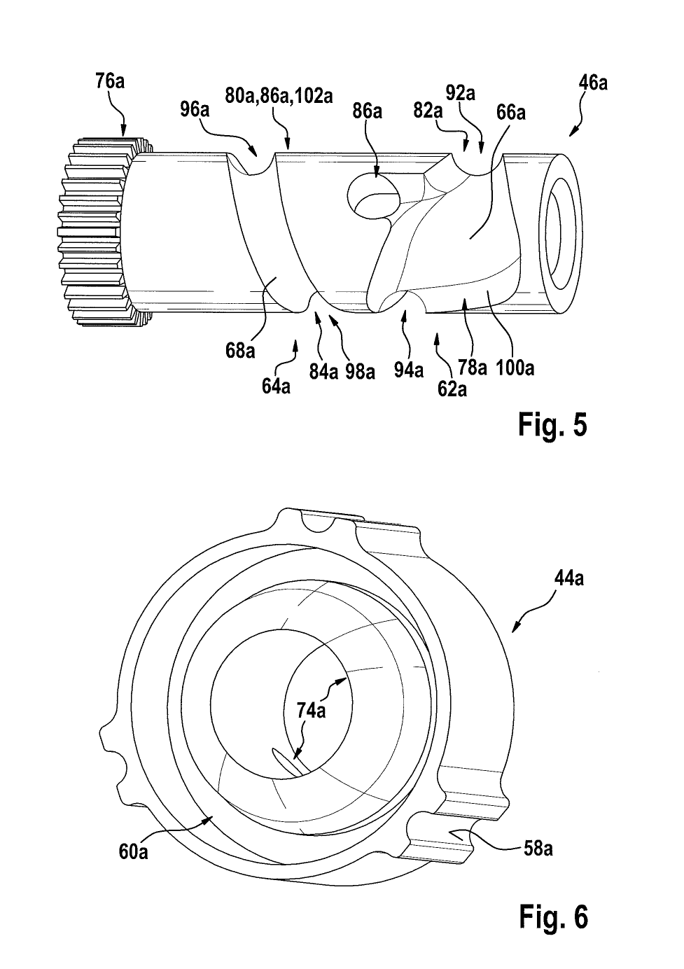

Impact mechanism spring 48a accelerates striker 44a in impact direction 54a prior to an impact. For this, handheld tool housing 14a braces impact mechanism spring 48a on a side facing away from striker 44a. Impact mechanism spring 48a pushes directly against striker 44a. Striker 44a has a spring mount 60a. Spring mount 60a is embodied as an annular depression. FIG. 5 shows impact mechanism spindle 46a in a perspective view. FIG. 6 shows striker 44a in a perspective view. Striker drive apparatus 50a has a first cam guide 62a and a second cam guide 64a. Cam guides 62a, 64a each encompass a guide cam 66a, 68a and a connecting arrangement 70a, 72a. Connecting arrangements 70a, 72a are embodied spherically. Striker 44a mounts connecting arrangement 70a, 72a in stationary fashion relative to striker 44a. Striker 44a has semi-spherical securing recesses 74a. In an impact-drill operating mode, connecting arrangement 70a, 72a slide in guide cam 66a, 68a. Impact mechanism spindle 46a encompasses a part of cam guides 62a, 64a, specifically guide cam 66a, 68a. Impact mechanism spindle 46a delimits a space in which connecting arrangement 70a, 72a move in an impact-drill operating mode.

Impact mechanism spindle 46a is embodied as a hollow shaft. Planetary gearbox 28a drives impact mechanism spindle 46a. For this, impact mechanism spindle 46a has, on a side facing away from tool chuck 36a, a tooth set 76a. Guide cams 66a, 68a each have an impact coasting region 78a, 80a, an impact lifting region 82a, 84a, and an installation recess 86a, 88a. Upon installation, connecting arrangement 70a, 72a are introduced through installation recesses 86a, 88a into securing recesses 74a of striker 44a. In an impact-drill operating mode, impact mechanism spindle 46a rotates clockwise (viewed in impact direction 54a). Impact lifting regions 82a, 84a are embodied helically. They extend through 180 degrees around a rotation axis 90a of impact mechanism spindle 46a. Impact lifting regions 82a, 84a move connecting arrangement 70a, 72a, and thus striker 44a, oppositely to impact direction 54a in an impact-drill operating mode. Impact mechanism 22a thus encompasses connecting arrangement 70a, 72a which, in at least one operating state, transfer a motion from impact mechanism spindle 46a to striker 44a.

Impact coasting regions 78a, 80a connect each two ends 92a, 94a, 96a, 98a of impact lifting regions 82a, 84a. Impact coasting regions 78a, 80a extend 180 degrees around a rotation axis 90a of impact mechanism spindle 46a. Impact coasting regions 78a, 80a each have an impact flank 100a, 102a that extends, proceeding from an end 94a, 96a of impact lifting region 82a facing toward planetary gearbox 28a, approximately parallel to impact direction 54a. After connecting arrangement 70a, 72a penetrate into impact coasting regions 78a, 80a, impact mechanism spring 48a accelerates striker 44a and connecting arrangement 70a, 72a in impact direction 54a. In that context, connecting arrangement 70a, 72a move through impact coasting regions 78a, 80a without experiencing an axial force, until striker 44a encounters impact surface 42a. Cam guides 62a, 64a are disposed with a 180-degree offset around rotation axis 90a. Cam guides 62a, 64a are disposed behind one another in an axial direction.

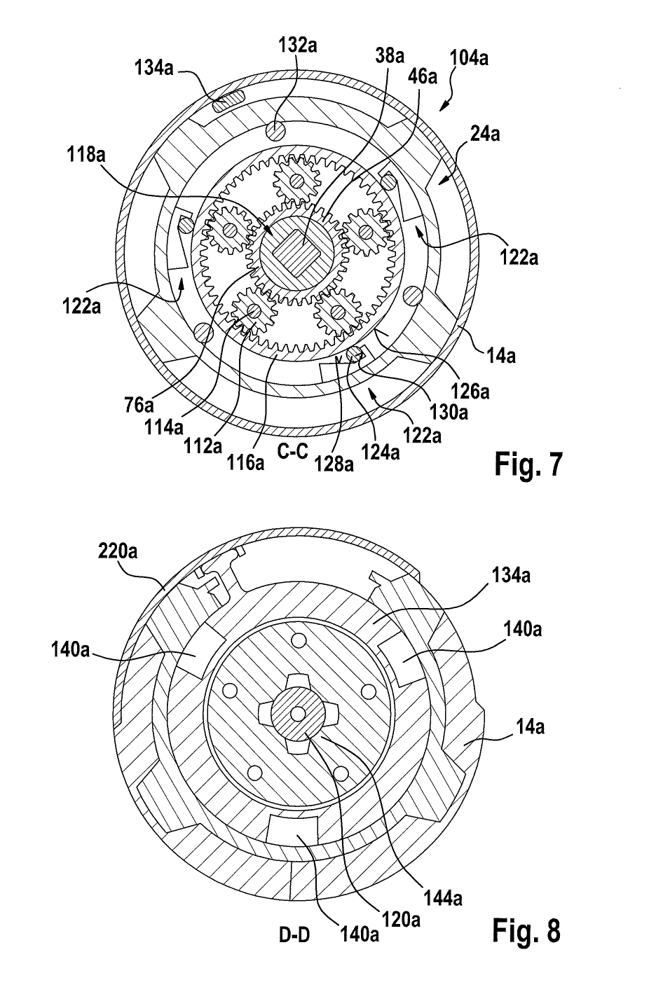

Planetary gearbox 28a encompasses first planetary gearbox stage 104a, a second planetary gearbox stage 106a, a third planetary gearbox stage 108a, and a fourth planetary gearbox stage 110. FIG. 7 shows a section surface C of first planetary gearbox stage 104a. The planetary gearbox stages 104a, 106a, 108a, 110a depicted in FIGS. 7, 12, 13, and 15 have gears having a number of teeth that seems appropriate to one skilled in the art. The gears of planetary gearbox stages 104a, 106a, 108a, 110a are in engagement with one another; this is in part not correspondingly depicted here. First planetary gearbox stage 104a increases a first rotation speed of second planetary gearbox 106a in order to drive impact mechanism 22a. Second planetary gearbox stage 106a drives tool spindle 38a at this first rotation speed. Tooth set 76a of impact mechanism spindle 46a constitutes a sun wheel of first planetary gearbox stage 104a. Tooth set 76a meshes with planet wheels 112a of first planetary gearbox stage 104a, which are guided by a planet carrier 114a of first planetary gearbox stage 104a. A ring gear 116a of first planetary gearbox stage 104a meshes with planet wheels 112a of first planetary gearbox stage 104a.

In an impact-drill operating mode, first impact deactivation mechanism 24a retains ring gear 116a of first planetary gearbox stage 104a immovably relative to handheld tool housing 14a. First impact deactivation mechanism 24a is provided in order to activate striker drive apparatus 50a in the context of a first, rightward drill rotation direction, and to automatically deactivate striker drive apparatus 50a in the context of a second, leftward drill rotation direction. First impact deactivation apparatus 24a acts on ring gear 116a of first planetary gearbox stage 104a. First impact deactivation apparatus 24a blocks ring gear 116a of first planetary gearbox stage 104a in the context of the first, rightward drill rotation direction. First impact deactivation mechanism 24a releases ring gear 116a of first planetary gearbox stage 104a in the context of the second, leftward drill rotation direction, so that said gear can rotate. For this, first impact deactivation apparatus 24a has three wedging mechanisms 122a. Wedging mechanisms 122a each encompass a blocking arrangement 124a, a first wedging surface 126a, a second wedging surface 128a, and freewheel surfaces 130a. Blocking arrangement 124a is embodied as a roller. First wedging surface 126a constitutes an externally located region of a surface of ring gear 116a of first planetary gearbox stage 104a. Second wedging surface 128a is disposed immovably relative to handheld tool housing 14a. Upon operation in the first, rightward drill rotation direction, blocking arrangement 124a wedge between first wedging surfaces 126a and second wedging surface 128a. Upon operation in the second, leftward drill rotation direction, freewheel surfaces 130a guide blocking arrangement 124a and prevent wedging.

FIG. 7 furthermore shows a connecting arrangement 118a that nonrotatably connects tool spindle 38a and a planet carrier 120a of second planetary gearbox stage 106a. Connecting arrangement 118a connects tool spindle 38a and planet carrier 120a of second planetary gearbox stage 106a axially displaceably in this case.

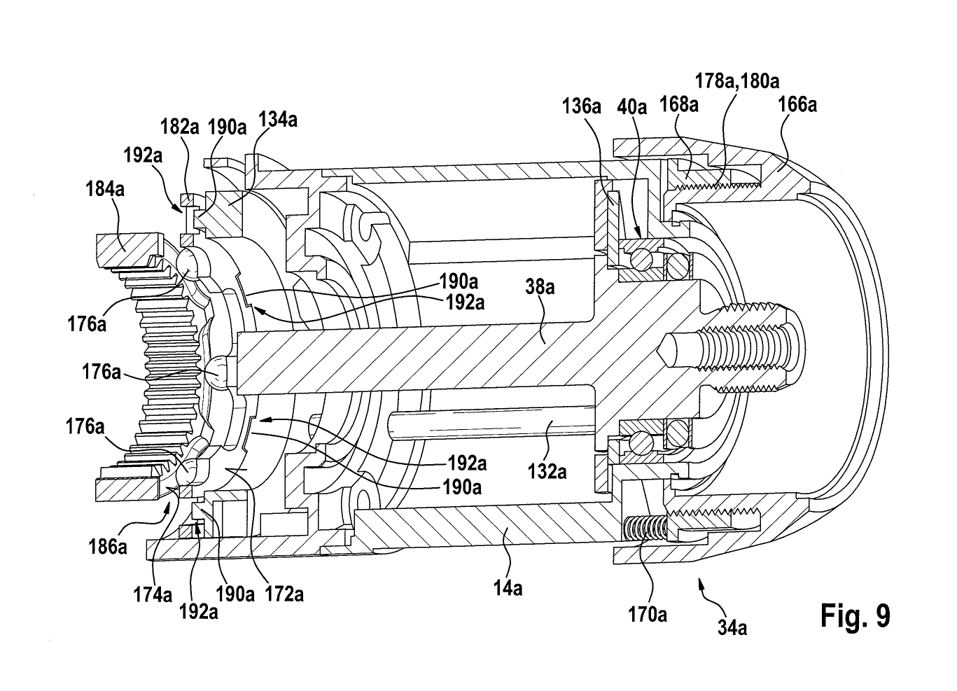

FIGS. 3, 4, and 7 furthermore show three first transfer arrangement 132a of second impact deactivation apparatus 26a. Transfer arrangement 132a is embodied as rods. FIG. 8 shows a section surface D through a control element 134a of handheld tool apparatus 12a. FIG. 9 is a perspective sectioned depiction of second impact deactivation apparatus 26a. In a screwdriving mode depicted in FIGS. 1, 8, and 9, and in a drilling mode, control element 134a braces tool guidance unit 20a in a direction opposite to impact direction 54a. A force applied onto tool guidance unit 20a acts on support surfaces 138a of control element 134a via mounting arrangement 40a, a second transfer arrangement 136a of second impact deactivation apparatus 26a, and first transfer arrangement 132a. Control element 134a has three recesses 140a. In an impact drilling mode depicted in FIG. 2, first transfer arrangement 132a can be slid into recesses 140a with the result that tool guidance unit 20a is axially movable.

Second impact deactivation apparatus 26a has an impact deactivation coupling 142a. Impact deactivation coupling 142a is embodied in part integrally with planetary gearbox 28a. Impact deactivation coupling 142a is disposed between first planetary gearbox stage 104a and second planetary gearbox stage 106a. Impact deactivation coupling 142a has a first coupling element 144a that is connected nonrotatably to a planet carrier 114a of first planetary gearbox stage 104a. Impact deactivation coupling 142a has a second coupling element 146a that is connected nonrotatably to a planet carrier 120a of second planetary gearbox stage 106a. In the screwdriving mode depicted, and in the drilling mode, impact deactivation coupling 142a is opened. In an impact-drill operating mode, tool spindle 38a transfers an axial coupling force to impact deactivation coupling 142a when the operator pushes an inserted tool against a workpiece. The coupling force closes impact deactivation coupling 142a. Impact deactivation coupling 142a is shown closed in FIG. 2. When the operator lifts the inserted tool away from the workpiece, an impact switching spring 148a of handheld tool apparatus 12a opens impact deactivation coupling 142a.

Planet carrier 120a of second planetary gearbox stage 106a is embodied in two parts. A first part 150a of planet carrier 120a of second planetary gearbox stage 106a is connected nonrotatably to tool spindle 38a. First part 150a of planet carrier 120a is connected axially displaceably to tool spindle 38a, with the result that planet carrier 120a remains rotationally coupled to tool spindle 38a even in an impact. First part 150a is thus permanently connected to tool spindle 38a. First part 150a of planet carrier 120a is mounted axially displaceably against impact switching spring 148a. A second part 152a of planet carrier 120a of second planetary gearbox stage 106a is connected nonrotatably to first part 150a of planet carrier 120a. First part 150a and second part 152a of planet carrier 120a are connected axially displaceably with respect to one another. First part 150a and second part 152a of planet carrier 120a are permanently connected nonrotatably.

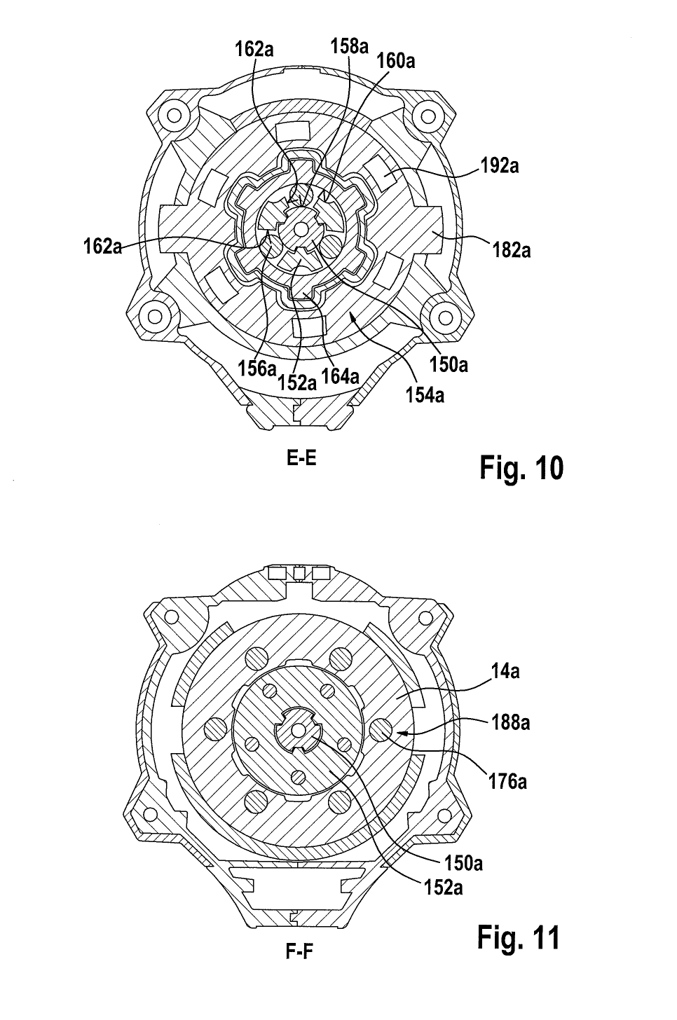

FIG. 10 shows a section surface of a spindle blocking apparatus 154a of handheld tool apparatus 12a. Spindle blocking apparatus 154a is provided in order to connect tool spindle 38a nonrotatably to handheld tool housing 14a when a tool torque is applied onto tool chuck 36a, for example upon clamping of an inserted tool into tool chuck 36a. Spindle blocking apparatus 154a is embodied in part integrally with planet carrier 120a of second planetary gearbox stage 106a. Spindle blocking apparatus 154a encompasses blocking arrangement 156a, first wedging surfaces 158a, a second wedging surface 160a, and freewheel surfaces 162a. Blocking arrangement 156a are embodied in roller form. First wedging surfaces 158a are embodied as regions of a surface of first part 150a of planet carrier 120a of second planetary gearbox stage 106a. First wedging surfaces 158a are planar in configuration. Second wedging surface 160a is embodied as an inner side of a wedging ring 164a of spindle blocking apparatus 154a. Wedging ring 164a is connected nonrotatably to handheld tool housing 14a. Freewheel surfaces 162a are embodied as regions of a surface of second part 152a of planet carrier 120a of second planetary gearbox stage 106a. When a tool torque is applied onto tool chuck 36a, blocking arrangement 156a wedge between first wedging surfaces 158a and second wedging surface 160a. When drive unit 30a is driving, freewheel surfaces 162a guide blocking arrangement 156a on a circular path and prevent wedging. First part 150a and second part 152a of planet carrier 120a are intermeshed with one another with clearance.

FIGS. 1, 2, 9, and 10 show torque limiting unit 34a. Torque limiting unit 34a is provided in order to limit, in a screwdriving mode, a maximum tool torque delivered by tool chuck 36a. Torque limiting unit 34a encompasses an operating element 166a, an adjusting element 168a, limiting springs 170a, transfer arrangement (not depicted in further detail), first stop surfaces 172a, a second stop surface 174a, and limiting arrangement 176a. Operating element 166a is embodied annularly. It is adjacent in the direction of planetary gearbox 28a to tool chuck 36a. Operating element 166a has a setting thread 178a that is coupled to a setting thread 180a of adjusting element 168a. Adjusting element 168a is mounted nonrotatably and axially displaceably. A rotation of operating element 166a displaces adjusting element 168a in an axial direction. Limiting springs 170a are braced on one side against adjusting element 168a. Limiting springs 170a are braced on another side, via the transfer arrangement, against a stop arrangement 182a of torque limiting unit 34a. A surface of stop arrangement 182a encompasses first stop surfaces 172a. In the screwdriving mode, stop arrangement 182a is mounted movably in an axial direction toward limiting springs 170a. Second stop surface 174a is embodied as a region of a surface of a ring gear 184a of second planetary gearbox stage 106a. Second stop surface 174a has trough-shaped depressions 186a. Limiting arrangement 176a are embodied spherically. Limiting arrangement 176a are mounted displaceably in impact direction 54a in tubular recesses 188a. FIG. 11 shows a section surface F of torque limiting unit 34a. In the context of a screwdriving operation, limiting arrangement 176a are disposed in trough-shaped depressions 186a, in which context limiting arrangement 176a nonrotatably secure ring gear 184a of second planetary gearbox stage 106a. When the maximum tool torque that has been set is reached, limiting arrangement 176a push stop arrangement 182a away against limiting springs 170a. Limiting arrangement 176a then jump into a respective next one of the trough-shaped depressions 186a; ring gear 184a of second planetary gearbox stage 106a rotates, with the result that the screwdriving operation is interrupted.

Control element 134a of handheld tool apparatus 12a has bracing arrangement 190a that, at least in the context of drilling operation, prevent an axial motion of stop arrangement 182a. For this, bracing arrangement 190a brace stop arrangement 182a in an axial direction. Stop arrangement 182a has screwdriving recesses 192a into which stop arrangement 182a penetrate, in the context of a screwdriving mode depicted in particular in FIG. 9, when the maximum tool torque is reached. Bracing arrangement 190a are correspondingly disposed in the context of a screwdriving position of control element 134a. In an impact-drill operating mode, bracing elements 190a likewise prevent an axial motion of stop arrangement 182a and thus prevent torque limiting unit 34a from responding. Alternatively, stop arrangement could likewise be disposed in an impact-drill operating mode so that they can penetrate into screwdriving recesses. A torque limiting unit would thus be active in the impact-drill operating mode.

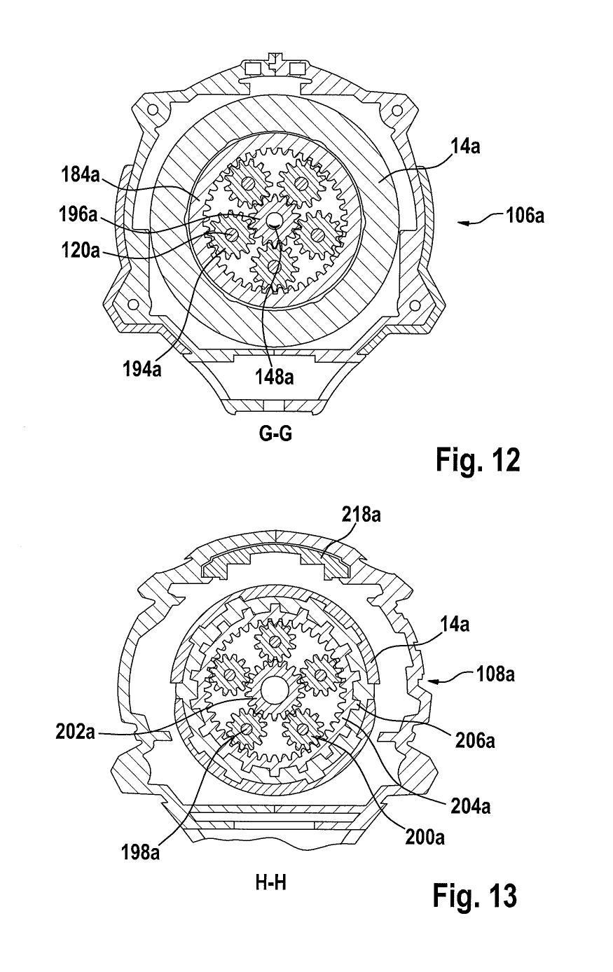

FIG. 12 shows a section surface G of second planetary gearbox stage 106a. Ring gear 184a of second planetary gearbox stage 106a is, at least in a drilling mode, mounted in handheld tool housing 14a in a manner secured against complete rotation. Planet wheels 194a of second planetary gearbox stage 106a mesh with ring gear 184a and with a sun wheel 196a of second planetary gearbox stage 106a.

FIG. 13 shows a section surface H of third planetary gearbox stage 108a. Sun wheel 196a of second planetary gearbox stage 106a is connected nonrotatably to a planet carrier 198a of third planetary gearbox stage 108a. Planet wheels 200a of third planetary gearbox stage 108a mesh with a sun wheel 202a and with a ring gear 204a of third planetary gearbox stage 108a. Ring gear 204a of third planetary gearbox stage 108a has a tooth set 206a that, in a first transmission ratio, connects ring gear 204a of third planetary gearbox stage 108a nonrotatably to handheld tool housing 14a.

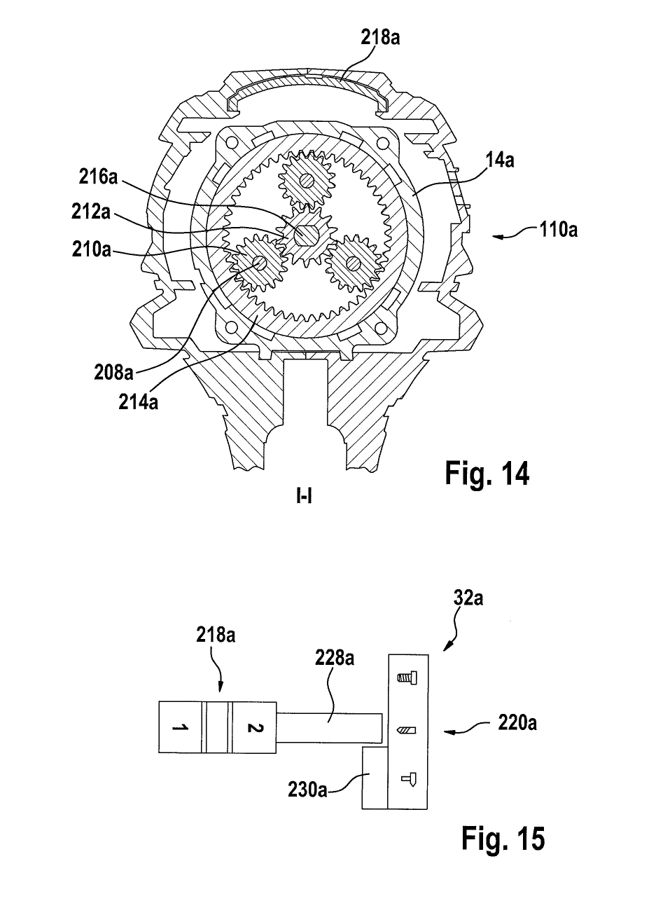

FIG. 14 shows a section surface I of third planetary gearbox stage 108a. Sun wheel 202a of third planetary gearbox stage 108a is connected nonrotatably to a planet carrier 208a of fourth planetary gearbox stage 110a. Planet wheels 210a of fourth planetary gearbox stage 110a mesh with a sun wheel 212a and with a ring gear 214a of fourth planetary gearbox stage 110a. Ring gear 214a is connected nonrotatably to handheld tool housing 14a. Sun wheel 212a of fourth planetary gearbox stage 110a is connected nonrotatably to a rotor 216a of drive unit 30a.

Ring gear 204a of third planetary gearbox stage 108a is, as shown in FIG. 2, mounted displaceably in an axial direction. In the first transmission ratio, ring gear 204a of third planetary gearbox stage 108a is connected nonrotatably to handheld tool housing 14a. In the second transmission ratio, ring gear 204a of third planetary gearbox stage 108a is connected nonrotatably to planet carrier 208a of fourth planetary gearbox stage 110a and is mounted rotatably relative to handheld tool housing 14a. The result is that a stepdown ratio of the first transmission ratio between rotor 216a of drive unit 30a and planet carrier 198a of third planetary gearbox stage 108a is greater than a stepdown ratio of the second transmission ratio.

Operating apparatus 32a has a first operating element 218a and a second operating element 220a. First operating element 218a is disposed on a side of handheld tool housing 14a facing away from handle 18a. Said element is mounted movably parallel to the axial direction of planetary gearbox 28a. First operating element 218a is connected, via an adjusting arrangement 222a of operating apparatus 32a, in an axial direction to ring gear 204a of third planetary gearbox stage 108a. Ring gear 204a of third planetary gearbox stage 108a has a groove 224a into which adjusting arrangement 222a engages. Ring gear 204a of third planetary gearbox stage 108a is thus connected in an axial direction to adjusting arrangement 222a, axially rotatably relative to adjusting arrangement 222a. Adjusting arrangement 222a is embodied resiliently, with the result that the transmission ratio can be adjusted independently of a rotational position of ring gear 204a of third planetary gearbox stage 108a. When first operating element 218a is slid in the direction of tool chuck 36a, the first transmission ratio is set. When second operating element 220a is slid away from tool chuck 36a, the second transmission ratio is set.

Second operating element 220a is disposed on a side of handheld tool housing 14a facing away from handle 18a. Second operating element 220a is disposed displaceably around an axis that is oriented parallel to the axial direction of planetary gearbox 28a. Second operating element 220a is connected nonrotatably to control element 134a of handheld tool apparatus 12a. The screwdriving mode, drilling mode, and impact drilling mode can be set by way of second operating element 220a. When second operating element 220a is slid to the left (viewed in impact direction 54a) the impact drilling mode is set. When second operating element 220a is slid to the right (viewed in impact direction 54a) the screwdriving mode is set. When second operating element 220a is disposed centeredly (viewed in impact direction 54a) the drilling mode is set.

FIG. 15 schematically shows a protective apparatus 226a of handheld tool apparatus 12a that, in the impact drilling mode, prevents operation at the first transmission ratio. In FIG. 14, the first transmission ratio and the drilling mode are set. Protective apparatus 226a is embodied in part integrally with operating apparatus 32a. A first locking arrangement 228a of protective apparatus 226a is shaped onto first operating element 218a. A second locking arrangement 230a of protective apparatus 226a is shaped onto second operating element 220a. Locking arrangement 228a are each embodied in tongue-shaped fashion. First locking arrangement 228a extends in the direction of second operating element 220a. Second locking arrangement 230a extends in the direction of first operating element 218a. Protective apparatus 226a prevents switching over into the impact drilling mode when the first transmission ratio is set. Protective apparatus 226a prevents switching over into the first transmission ratio when the impact drilling mode is set.

Drive unit 30a is embodied as an electric motor. Drive unit 30a has a maximum torque that causes a maximum tool torque in the first transmission ratio of more than 15 Nm and in the second transmission ratio of less than 15 Nm. The maximum tool torque in the first transmission ratio is equal to 30 Nm. The maximum tool torque in the second transmission ratio is equal to 10 Nm. The tool torque is to be determined in this context in accordance with the DIN EN 60745 standard.

In an impact-drill operating mode, impact switching spring 148a of handheld tool apparatus 12a opens impact deactivation coupling 142a when the operator lifts the inserted tool away from the workpiece. Impact switching spring 148a is disposed coaxially with planetary gearbox stages 104a, 106a, 108a, 110a, of planetary gearbox 28a. Second planetary gearbox stage 106a and third planetary gearbox stage 108a each surround impact switching spring 148a at least on a plane that is oriented perpendicularly to the axial direction of planetary gearbox 28a. Second planetary gearbox stage 106a and third planetary gearbox stage 108a are each disposed in terms of effect between at least two further planetary gearbox stages 104a, 106a, 108a, 110a of planetary gearbox 28a. Planet carrier 120a of second planetary gearbox stage 106a braces impact switching spring 148a on a side facing away from tool chuck 36a.

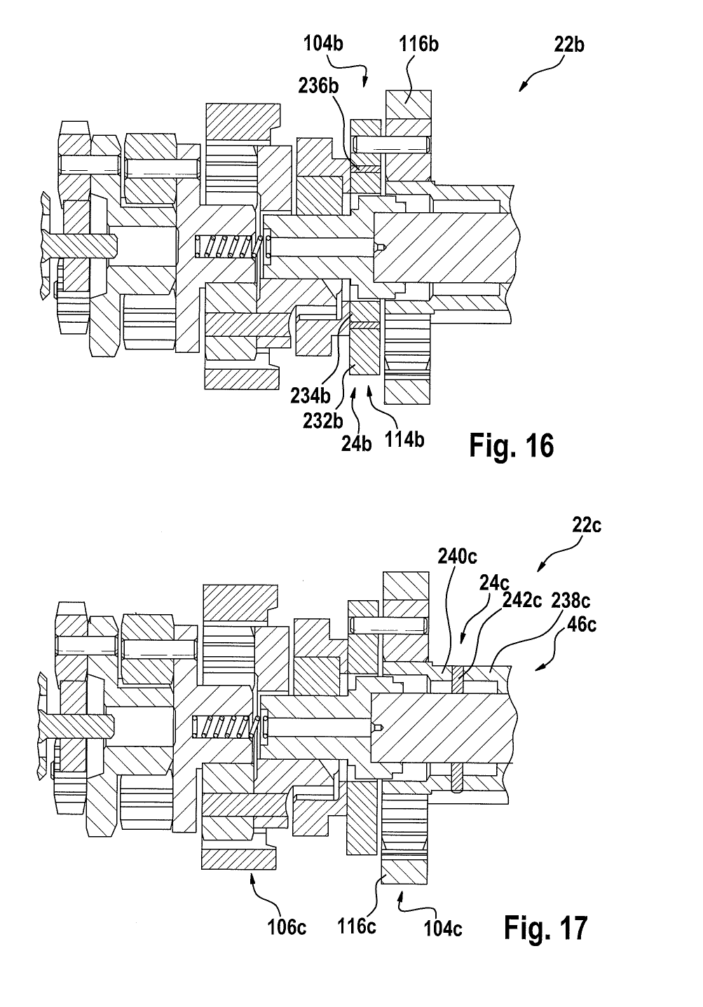

FIGS. 16 to 19 show further exemplifying embodiments of the invention. The descriptions below, and the drawings, are confined substantially to the differences between the exemplifying embodiments; with regard to identically named components, in particular with regard to components having identical reference characters, reference may as a matter of principle also be made to the drawings and/or to the description of the other exemplifying embodiments, in particular of FIGS. 1 to 15. To differentiate the exemplifying embodiments, the letter “a” is appended to the reference characters of the exemplifying embodiments in FIGS. 1 to 15. In the exemplifying embodiments of FIGS. 16 to 19, the letter “a” is replaced by the letters “b” to “e”.

FIG. 16 schematically depicts a further, alternative exemplifying embodiment of a first impact deactivation apparatus 24b. A planet carrier 114b of a first planetary gearbox stage 104b is embodied in two parts. A first part 232b of planet carrier 114b guides planet wheels 112b of first planetary gearbox stage 104b. A second part 234b of planet carrier 114b is rotationally coupled to a second planetary gearbox stage 106b. A first impact deactivation apparatus 24b of an impact mechanism 22b has a freewheel 236b, which seems appropriate to one skilled in the art and which nonrotatably connects first part 232b and second part 234b of planet carrier 114b in the context of a rightward drill rotation direction, and disconnects them in the context of a leftward drill rotation direction. A ring gear 116b of first planetary gearbox stage 104b is connected permanently nonrotatably to a handheld tool housing.

FIG. 17 schematically depicts a subsequent exemplifying embodiment of a first impact deactivation apparatus 24c. An impact mechanism spindle 46c of an impact mechanism 22c is embodied in two parts. A first part 238c of impact mechanism spindle 46c is connected to a striker drive apparatus. A second part 240c of impact mechanism spindle 46c is connected to a second planetary gearbox stage 106c. First impact deactivation apparatus 24c has a freewheel 242c, which seems appropriate to one skilled in the art and which nonrotatably connects first part 238c and second part 240c of impact mechanism spindle 46c in the context of a rightward drill rotation direction, and disconnects them in the context of a leftward drill rotation direction. A ring gear 116c of first planetary gearbox stage 104c is connected permanently nonrotatably to a handheld tool housing.

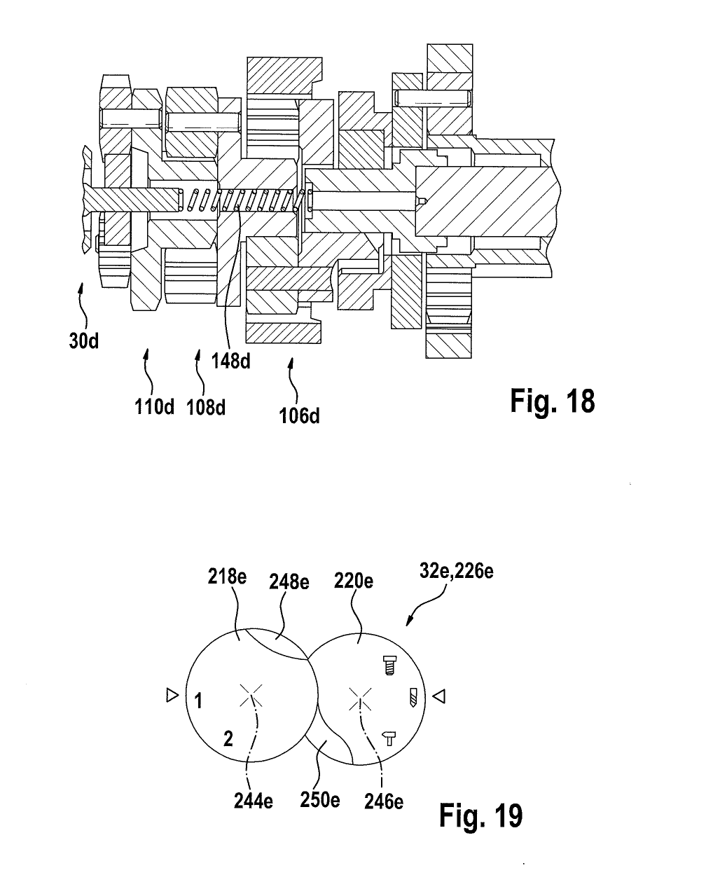

FIG. 18 depicts a further exemplifying embodiment of an impact switching spring 148d. A second planetary gearbox stage 106d braces impact switching spring 148d on a side facing toward a tool chuck. A drive unit 30d braces impact switching spring 148d on a side facing away from a tool chuck. Second planetary gearbox stage 106d, a third planetary gearbox stage 108d, and a fourth planetary gearbox stage 110d each surround impact switching spring 148d at least on a plane that is oriented perpendicularly to an axial direction of planetary gearbox stages 106d, 108d, 110d. Drive unit 30d is connected nonrotatably to a part of planetary gearbox stage 110d.

FIG. 19 shows an alternative exemplifying embodiment of operating apparatus 32e and of a protective apparatus 226e. Operating apparatus 32e has a first operating element 218e and a second operating element 220e. Operating elements 218e, 220e are mounted pivotably around rotation axes 244e, 246e. Operating elements 218e, 220e have a disc-shaped basic shape. First operating element 218e is connected (not depicted in further detail) to a planetary gearbox via a mechanism that seems appropriate to one skilled in the art. A first transmission ratio and a second transmission ratio can be set by way of first operating element 218e. Second operating element 220e is connected (not depicted in further detail) to a control element via a mechanism that seems appropriate to one skilled in the art. A screwdriving mode, a drilling mode, and an impact drilling mode can be set by way of second operating element 220e. A hammer mode can furthermore be set.

Protective apparatus 226e has a freewheel region 248e delimited by first operating element 218e. Protective apparatus 226e has a freewheel region 250e delimited by second operating element 220e. Freewheel region 248e of first operating element 218e allows the screwdriving mode, the drilling mode, and the impact drilling mode to be set when a second transmission ratio is set. Freewheel region 250e of second operating element 220e allows the screwdriving mode and the drilling mode to be set when a first transmission ratio is set. In the impact drilling mode, protective apparatus 226e prevents the first transmission ratio from being set. When the first transmission ratio is set, protective apparatus 226e prevents the impact drilling mode from being set.

What is claimed is:

1. A handheld tool apparatus, comprising:
a tool guidance unit having a tool spindle and a tool chuck; and
an impact mechanism having a striker that in at least one operating state percussively drives the tool guidance unit, wherein a mass of the striker is at maximum two thirds as great as a mass of the tool guidance unit.

2. The handheld tool apparatus of claim 1, wherein the mass of the striker is at maximum half as great as the mass of the tool guidance unit.

3. The handheld tool apparatus of claim 1, wherein a mass of the striker is equal to at minimum 35% of a mass of the tool guidance unit.

4. The handheld tool apparatus of claim 1, wherein the tool spindle has an impact surface onto which the striker strikes in at least one operating mode.

5. The handheld tool apparatus of claim 1, wherein the striker surrounds the tool spindle on at least one plane.

6. The handheld tool apparatus of claim 1, wherein the impact mechanism has at least one cam guide that drives the striker at least in an impact-drill operating mode.

7. The handheld tool apparatus of claim 6, wherein the striker encompasses a part of the cam guide.

8. The handheld tool apparatus of claim 1, wherein the impact mechanism has an impact mechanism spring that accelerates the striker in an impact direction at least in an impact-drill operating mode.

9. The handheld tool apparatus of claim 1, wherein the impact mechanism has an impact mechanism spindle that surrounds the tool spindle on at least one plane.

10. The handheld tool apparatus of claim 1, wherein the impact mechanism has a striker guide that nonrotatably mounts the striker.

11. A handheld tool, comprising:
a handheld tool apparatus, including:
a tool guidance unit having a tool spindle and a tool chuck; and
an impact mechanism having a striker that in at least one operating state percussively drives the tool guidance unit, wherein a mass of the striker is at maximum two thirds as great as a mass of the tool guidance unit.

12. The handheld tool of claim 11, wherein the mass of the striker is at maximum half as great as the mass of the tool guidance unit.

13. The handheld tool of claim 11, wherein a mass of the striker is equal to at minimum 35% of a mass of the tool guidance unit.

14. The handheld tool of claim 11, wherein the tool spindle has an impact surface onto which the striker strikes in at least one operating mode.

15. The handheld tool of claim 11, wherein the striker surrounds the tool spindle on at least one plane.

16. The handheld tool of claim 11, wherein the impact mechanism has at least one cam guide that drives the striker at least in an impact-drill operating mode.

17. The handheld tool of claim 16, wherein the striker encompasses a part of the cam guide.

18. The handheld tool of claim 11, wherein the impact mechanism has an impact mechanism spring that accelerates the striker in an impact direction at least in an impact-drill operating mode.

19. The handheld tool of claim 11, wherein the impact mechanism has an impact mechanism spindle that surrounds the tool spindle on at least one plane.

20. The handheld tool of claim 11, wherein the impact mechanism has a striker guide that nonrotatably mounts the striker.
